(19) United States
(12) Patent Application Publication
(10) Pub. No.: US 2007/0220236 A1
(43) Pub. Date: Sep. 20, 2007

(54) Reconfigurable computing device

(75) Inventor: Ichiro Kasama, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/488,159

(22) Filed: Jul. 18, 2006

(30) Foreign Application Priority Data
Mar. 17, 2006 (JP) 2006-075393

(51) Int. Cl. G06F 9/44

(52) U.S. Cl. 712/226

(57) ABSTRACT

A reconfigurable computing device includes computing unit groups each of which includes at least one computing unit; a bus network that is reconfigurable and that uses arbitrary output data of the computing unit groups as arbitrary input data for the computing unit groups; a sequencer that outputs address information for controlling circuit configurations of the computing unit groups and switch-timing signals; and a configuration output unit that makes circuits of the computing unit groups reconfigurable for each of the computing unit groups, based on the address information and the switch-timing signals.

### CROSS-REFERENCE TO RELATED APPLICATIONS

This application is based upon and claims the benefit of priority from the prior Japanese Patent Application No. 2006-075393, filed on Mar. 17, 2006, the entire contents of which are incorporated herein by reference.

### BACKGROUND OF THE INVENTION

1. Field of the Invention

The present invention relates to a reconfigurable computing device.

2. Description of the Related Art

FIG. 1 is a schematic of a conventional reconfigurable computing device. A conventional reconfigurable computing device 1 decodes address information output from a sequencer 11, with reference to a table 13 in a circuit configuration output unit 12. Then, the reconfigurable computing device 1 outputs an actual instruction code of a computing unit and the like to a plurality of computing unit groups 14, 15, and 16. When the address is a specific address, the computing unit groups 14, 15, and 16 are collectively reconfigured, based on a switch-timing signal output from the sequencer 11.

FIG. 2 is a schematic for illustrating a three-level pipeline operation of the computing unit 1. As shown in FIG. 2, if data is input three times, circuit configurations of the computing unit groups 14, 15, and 16 in the first level, the second level, and the third level are switched, and data 1 is input into the computing unit group 14 in the first level. The pipeline processing of data 1, data 2, and data 3 are completed, and data 3 is output from the computing unit group 16 in the third level. Then, the circuit configurations of the computing unit groups 14, 15, and 16 in the first level, the second level, and the third level are switched.

A data processing unit having the following configuration is known as a reconfigurable computing device. The data processing device includes at least one processing unit, a unit that can fetch an instruction set, a first execution control unit, and a second execution control unit (for example, International Publication Pamphlet No. 01/16710). The processing unit performs calculations or other data processing. The unit that can fetch an instruction set has a first field and a second field. An executive instruction indicating the details of the calculation or other data processing performed by the processing unit can be written in the first field. Preparation information can be written in the second field. The preparation information sets the processing unit to a state in which calculation or other data processing, executed through the executive instruction, can be performed. The first execution control unit decodes the executive instruction in the first field and carries out the calculation or other data processing operation, of which instruction is given in the executive instruction, performed by the processing unit which is set in advance to allow the execution of the calculation or other data processing. The second execution control unit decodes the preparation information in the second field and sets the processing unit to a state in which the calculation and other data processing can be performed, independent of the execution details in the first execution control unit.

A data processing unit having the following configuration is also known. The data processing unit includes a plurality of processing units, a unit that can fetch a data flow specifying instruction, and a data flow specifying unit (for example, refer to International Publication Pamphlet No. 01/16711). The processing units can change at least one of an input interface and an output interface. The data flow specifying instruction specifies at least one of the input interface and the output interface of at least one processing unit, independent of a period processing is performed by the processing unit. The data flow specifying unit decodes the data flow specifying instruction, sets at least one of the input interface and the output interface of the processing unit, and can configure a data path formed by the processing units.

The inventors of the present invention have filed a patent application regarding a reconfigurable computing device. The reconfigurable computing device in the patent application includes a plurality of computing units, at least one memory unit, various processing elements required by the computing unit, an inter-resource reciprocal connecting unit, a storage unit, a loading unit, and a supplying unit. The computing units can be reconfigured by a given first configuration data and can operate simultaneously. The memory unit can be read from and written to, at will. The inter-resource reciprocal connecting unit arbitrary output data from the computing units and the memory unit to become arbitrary input data of the computing units. The inter-resource reciprocal connecting unit also performs data transfer between the computing units, the memory unit, and resources including the processing elements at an equal transfer speed, almost without influence by positions and types of the resources. Furthermore, the inter-resource reciprocal connecting unit can be reconfigured by a given second configuration data. The storage unit stores the first configuration data and the second configuration data. The loading unit loads the first configuration data and the second configuration data to the storage unit from an external memory device. The supplying unit supplies the first configuration data and the second configuration data in an appropriate sequence and timing to the inter-resource reciprocal connecting unit for example, refer to Japanese Patent Laid-open Publication No. 2006-31127.

In the conventional reconfigurable computing device, the circuit configurations of the all computing unit groups are switched collectively. Therefore, as shown in FIG. 2, when the pipeline processing is performed by the computing unit groups, the computing unit groups in the second and subsequent levels are required to wait for data in the initial stage. In addition, the computing unit groups in the levels before the last level are required to wait for data in the last stage. The data latencies in the computing unit groups increase as the number of times the circuit configurations are reconfigured increases, thereby reducing process efficiency of the computing unit.

This reduction also occurs in the data processing units disclosed in the International Publication Pamphlet No. 01/16710 and the International Publication Pamphlet No. 01/16711. Furthermore, in these data processing units, the circuit configurations can be collectively switched upon confirmation that calculation in a calculation processing unit array unit has been completed. Therefore, a penalty of several ten cycles may occur, when the timing at which the circuit configurations are actually switched is taken into consideration.

### SUMMARY OF THE INVENTION

It is an object of the present invention to at least solve the above problems in the conventional technologies.

A reconfigurable computing device according to one aspect of the present invention includes computing unit groups each of which includes at least one computing unit; a bus network that is reconfigurable and that uses arbitrary output data of the computing unit groups as arbitrary input data for the computing unit groups; a sequencer that outputs address information for controlling circuit configurations of the computing unit groups and switch-timing signals; and a configuration output unit that makes circuits of the computing unit groups reconfigurable for each of the computing unit groups, based on the address information and the switch-timing signals.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic of a conventional computing unit.

FIG. 2 is a schematic for illustrating a three-level pipeline operation of the computing unit shown in FIG. 1.

FIG. 3 is a schematic of an integrated circuit device including a reconfigurable computing device according to embodiments of the present invention;

FIG. 4 is a schematic of a computing unit according to the embodiment;

FIG. 5 is a schematic of a simple display unit included in the computing unit;

FIG. 6 is a schematic of a pattern output circuit included in the computing unit;

FIG. 7 is a schematic of a pattern output circuit included in the computing unit;

FIG. 8 is a schematic of an enable signal delay unit included in the computing unit;

FIG. 9 is a schematic for illustrating a configuration of a three-level pipeline in the computing unit;

FIG. 10 is a schematic for illustrating a configuration of a parallel three-level pipeline in the computing unit;

FIG. 11 is a schematic for illustrating a configuration of a six-level pipeline in the computing unit;

FIG. 12 is a schematic for illustrating an operation state of each computing unit group when the computing unit having the three-layer configuration is operated; and

FIG. 13 is a schematic for illustrating an operation state of each computing unit group when a conventional computing unit having the three-layer configuration is operated.

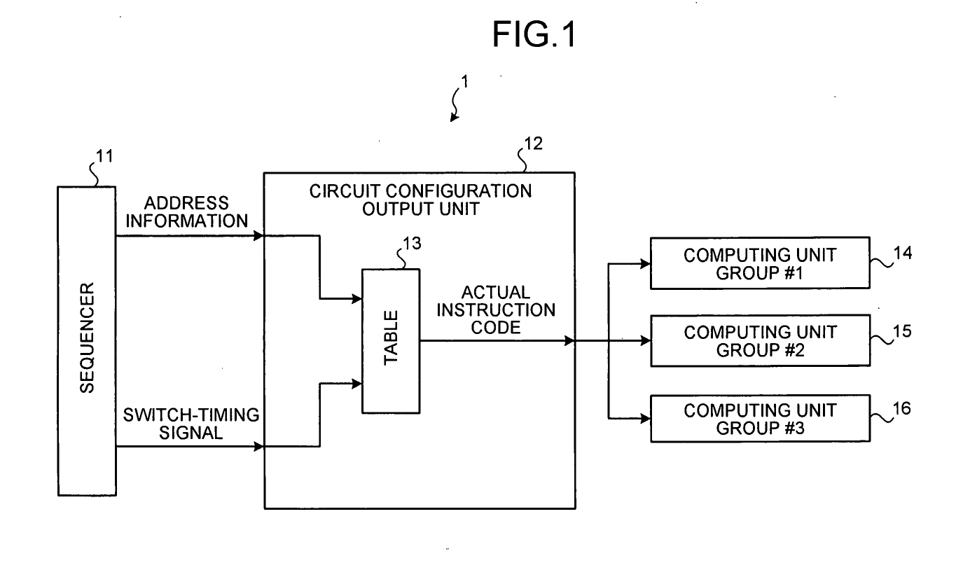

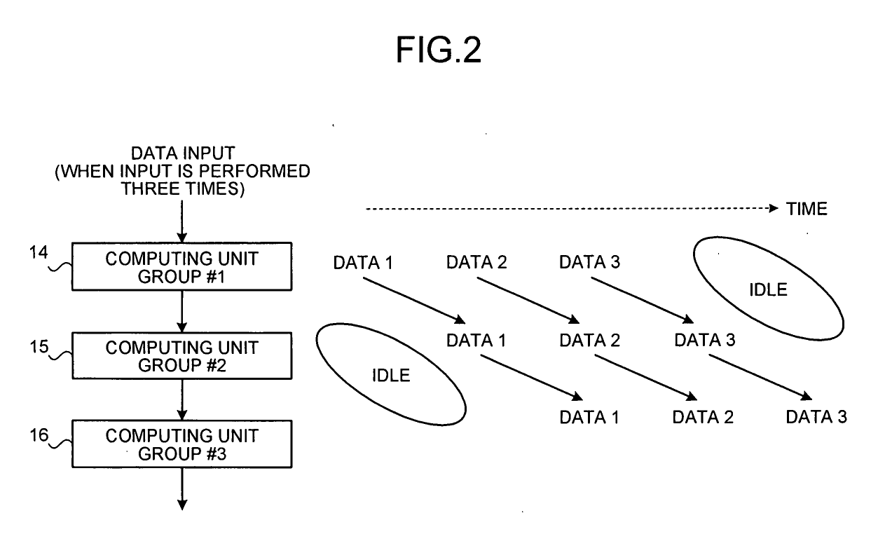

### DETAILED DESCRIPTION OF THE PREFERRED EMBODIMENTS

Exemplary embodiments according to the present invention will be explained in detail below with reference to the accompanying drawings. Same constituent elements within the accompanying drawings are given the same reference number. Redundant explanations are omitted.

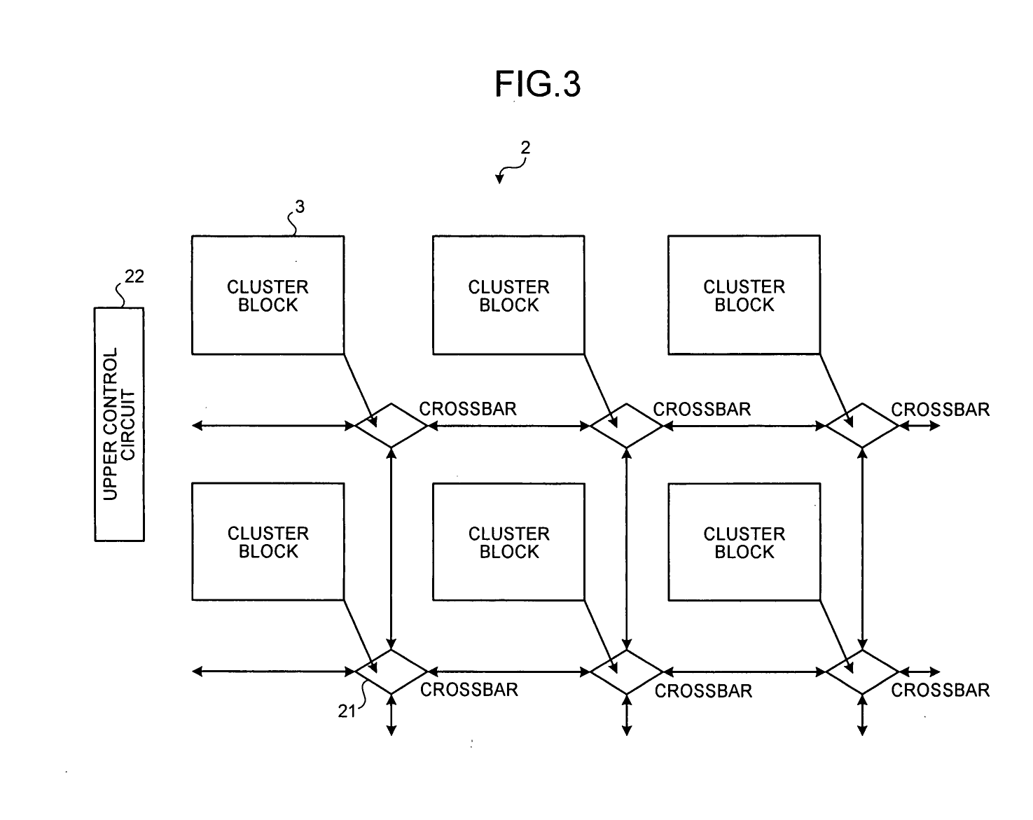

FIG. 3 is a schematic of an integrated circuit device including a reconfigurable computing device according to the present invention. An integrated circuit device 2 includes a plurality of reconfigurable computing devices 3, referred to as cluster blocks (although not particularly limited thereto, six computing units are exemplified in the diagram). Each computing unit 3 is interconnected via crossbars 21, to mutually transmit and receive data. The configurations of an input and output path for inputting and outputting data to and from each computing unit 3 and a data path composed of the crossbars 21 are controlled by an upper control circuit 22.

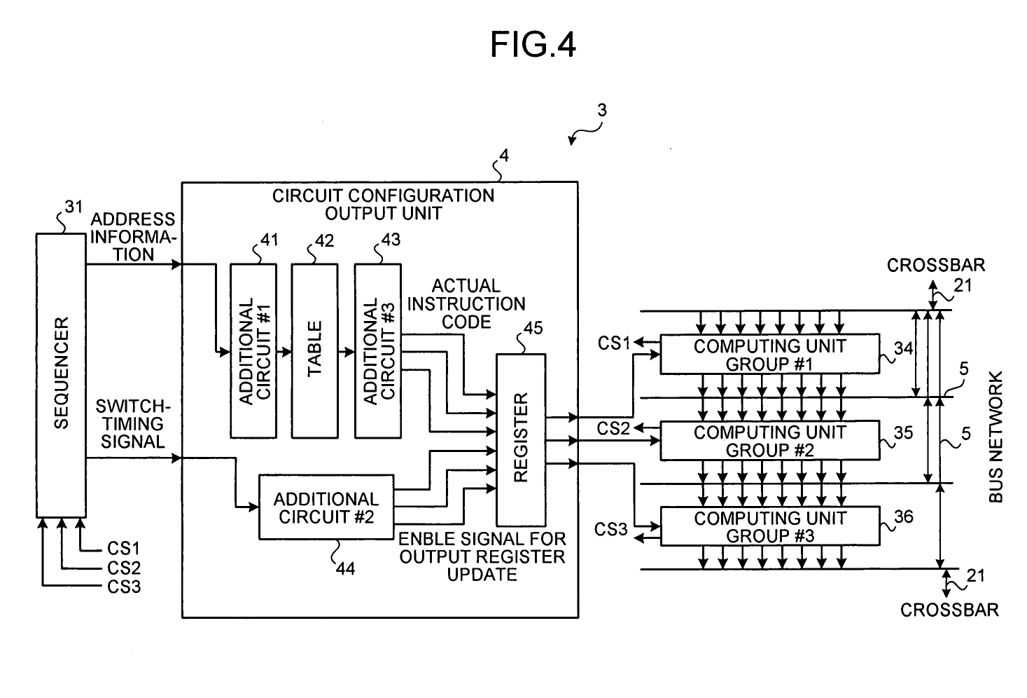

FIG. 4 is a schematic of the computing unit according the embodiments of the invention. The arithmetic device 3 includes a sequencer 31, a circuit configuration output unit 4, a plurality of computing unit groups 34, 35, and 36 (although not particularly limited thereto, three computing unit groups are exemplified in the diagram), and a bus network 5. Each computing unit group 34, 35, and 36 includes at least one computing unit. For example, each computing unit group 34, 35, and 36 includes at least one multiplier and at least one adder.

Data paths between the multipliers and the adders and data path between the computing units and other various circuit elements can be reconfigured based on wiring information. The data paths are reconfigured in time with a process performed by the computing unit 3. The number of computing unit groups can be two, four, or more, or even, for example, a dozen or several tens. Although three computing unit groups are used in the example explained herein, the same explanation applies to when a differing number of computing unit groups is used.

The sequencer 31 outputs address information for controlling the circuit configurations of the computing unit groups 34, 35, and 36, and switch-timing signals. The bus network 5 allows output data of the computing units 34, 35, and 36 to be used as input data, respectively. In addition, the bus network 5 allows the output data to be used as input data for other computing unit groups within the same computing unit 3. The bus network can be reconfigured based on the wiring information and the like and are reconfigured in time with a process performed by the computing unit 3. The bus network 5 and the bus network within other computing units can be inter-connected via the crossbars 21.

The circuit configuration output unit 4 includes at least one, or two or more, of a table 42, a first additional circuit 41, a second additional circuit 44, and a third additional circuit 43. Although the circuit configuration output unit 4 is not required to have all of the table 42, the first additional circuit 41, the second additional circuit 44, and the third additional circuit 43, a state including all of the above is shown in FIG. 4. Required components are selected and used among the table 42, the first additional circuit 41, the second additional circuit 44, and the third additional circuit 43, as required, depending on the application of the integrated circuit device 2 and the processes performed by the computing unit 3.

When the circuit configuration output unit 4 controls the circuit configuration switching of the computing unit groups 34, 35, and 36, by each group, the circuit configuration output unit 4 includes a register 45. The register 45 temporarily stores the address information to be sent to each computing unit group 34, 35, and 36 from the circuit configuration output unit 4, and outputs the information to each computing unit group 34, 35, and 36 by each group at the timing control is performed. If the circuit configurations of the computing unit groups 34, 35, and 36 are collectively switched, the register 45 is unnecessary.

The table 42 outputs address information corresponding to the input address information and executive codes of the computing units and the like. The first additional circuit 41 includes, for example, a simple delay unit, a specific cycle count delay unit, an arithmetic operator, a logic operator, an address decoding circuit having a look-up table, or a through-data circuit. The first additional circuit 41 performs a process, below, on the address information output from the sequencer 31.

In the simple delay unit, the register 45 delays the switch-timing signal, output from the sequencer 31, by each group when specific address information is output from the sequencer 31. As a result, the output timings of the address information to the computing unit groups 34, 35, and 36, are delayed by each group. The specific cycle count delay unit includes a counter in place of the register 45 in the simple delay unit, thereby performing a delay of a larger number of cycles that the simple delay unit.

When address information other than the specific address information is output from the sequencer 31, the simple delay unit and the specific cycle count delay unit do not perform any processing on the address information. If the first additional cycle is the simple delay unit or the specific cycle count delay unit, the switch-timing at which each computing unit group 34, 35, and 36 is reconfigured can be changed by each group. If the number of delay cycles is the same for each computing unit group 34, 35, 36, the configurations of each computing unit group 34, 35, 36 can be collectively switched.

The arithmetic operator performs an arithmetic operation on the address information output from the sequencer 31 and dynamically changes the address information. The logic operator performs a logic operation on the address information output from the sequencer 31 and dynamically changes the address information. The address decoding circuit uses the look-up table and decodes the address information output from the sequencer 31. If the first additional circuit is the arithmetic operator, the logic operator, or the address decoding circuit, reference addresses of the table 42 can be dynamically changed. The through-data circuit does not perform any processing on the address information output from the sequencer 31.

The third additional circuit 43 includes, for example, the simple delay unit, the specific cycle count delay unit, the arithmetic operator, the logical operator, the address decoding circuit using look-up data, the through-data circuit, or a pattern output circuit having a counter and memory. The delay units, operators and circuits (excluding the pattern output circuit) perform the same processes on the address information output from the table 42 as the delay units, operators and circuits of the first additional circuit 41.

The pattern output circuit starts the counter when specific address information is output from the table 42. The pattern output circuit reads memory information corresponding to the counter value from the memory and outputs the information to the computing unit groups 34, 35, and 36. When there is no table 42 but there is the first addition circuit 41, the process above is performed when the specific address information is output from the first additional circuit 41. If there is neither the table 41 nor the first additional circuit 41, the process is performed when the specific address information is output from the sequencer 31.

When address information other than the specific address information is input into the pattern output circuit, the pattern output circuit does not perform any processing on the address information. If the third additional circuit 43 is the pattern output circuit, the circuit configuration output unit 4 can output plural pieces of address information to each computing unit group 34, 35, and 36 when the address information is output from the sequencer 31 once.

The second additional circuit 44 includes, for example, an enable signal delay unit or and enable signal distributor. In the enable signal delay unit, when the specific address information is output from the sequencer 31, the register 45 delays the switch-timing signal output from the sequencer 31 and the signal is output as an enable signal allowing the output of address information from the register 45. To delay the switch timing by a plural number of cycles, the switch-timing signal is delayed by a predetermined number of cycles using the counter that starts counting by the input of the specific address information.

The enable signal delay unit can control the timings at which the address information is provided to each computing unit group 34, 35, and 36, by each group. When address information other than the specific address information is input into the enable signal delay unit, the enable signal delay unit outputs the switch-timing signal output from the sequencer 31 to the register 45, as it is. The enable signal distributor distributes the switch-timing signal output from the sequencer 31 to the computing unit groups 34, 35, and 36, by each group.

Whether the circuit configuration output unit 4 includes the table 42, the first additional circuit 41, and the third additional circuit 43 is selected accordingly for each cluster block of the integrated circuit device 2 (see FIG. 3). Which among the operators, or the circuits, described above, the first additional circuit 41 and the third additional circuit 43 are is also selected accordingly for each cluster block of the integrated circuit device 2. Whether the second additional circuit 44 is the enable signal delay unit or the enable signal distributor is selected accordingly for each cluster block of the integrated circuit 2, as well. The first additional circuit 41 and the third additional circuit 43 can issue a plurality of instructions by one operational instruction from the sequencer 31. The issuance timing of the instructions can be variable. Furthermore, the enable signal determining the actual issuance timing can be controlled in the same way.

In the computing unit 3, the following three modes can be actualized as modes for switching the configuration of each computing unit group 34, 35, and 36. A first mode is an independent mode. In the independent mode, the sequencer 31 makes judgment independently and switches the configuration of each computing unit group 34, 35, and 36. A second mode is a calculation result mode. In calculation result mode, the sequencer switches the configuration of each calculation unit group 34, 35, and 36 based on any one of circuit-switch request signals CS1, CS2, and CS3, output from the computing unit groups 34, 35, and 36, upon completion of respective calculations.

A third mode is a mode in which the circuit configuration output unit 4 independently switches the configuration of each calculation unit group 34, 35, and 36 based on information on the counter, addresses, and the like in the circuit configuration output unit 4. The actualization of the three modes allows the implementation of complicated FOR loop statements and the like, which could not be actualized in the conventional reconfigurable computing device 1.

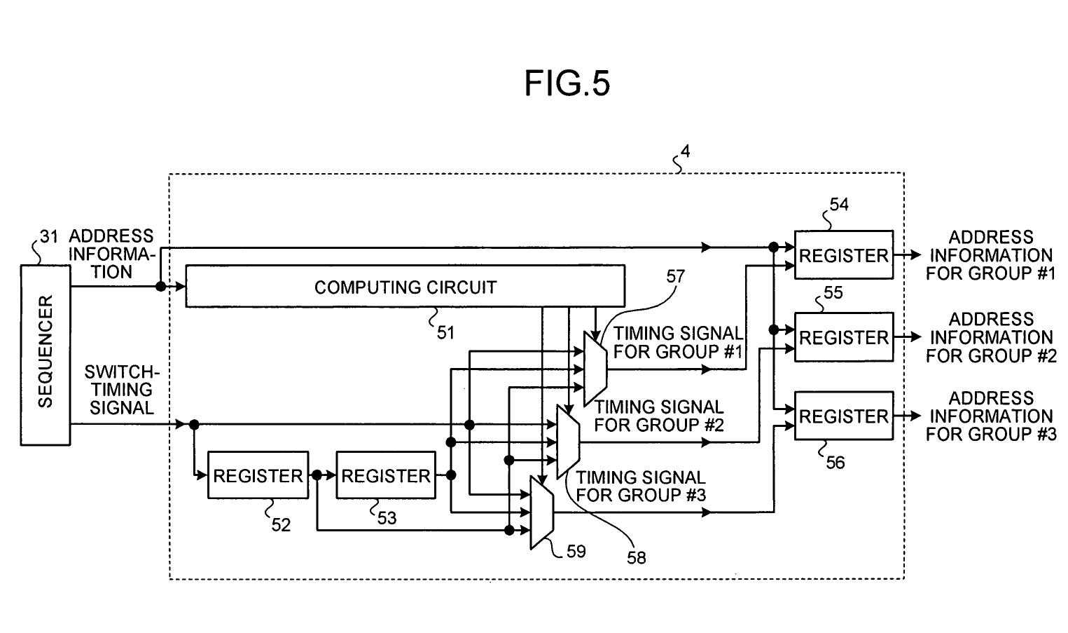

FIG. 5 is a schematic of the simple display unit in the computing unit. The circuit configuration output unit 4 includes an arithmetic circuit 51, registers 52, 53, 54, 55, and 56, and selectors 57, 58, and 59. The arithmetic circuit 51 controls the outputs of the selectors 57, 58, and 59 when the specific address information is provided from the sequencer 31.

In the circuit configuration output unit 4, the address information output from the sequencer 31 is sent to and temporarily held in the register 54 for the computing unit groups in the first level, the register 55 for the computing unit groups in the second level, and the register 56 for the computing unit groups in the third level. The three registers 54, 55, and 56 are equivalent to the register 45 in the overall diagram of the computing unit 3 shown in FIG. 4. The enable signal allowing the output of address information to each register 54, 55, and 56 are provided from the selector 57 for the computing unit groups in the first level, the selector 58 for the computing unit groups in the second level, and the selector 59 for the computing unit groups in the third level.

Each selector 57, 58, and 59 selects one signal among the switch-timing signal that has been delayed by the register 52 of the previous level, and the output signal of the register 52 of the previous level that has been further delayed by the register 53 of the subsequent level, and outputs the selected signal. When the specific address information is provided to the arithmetic circuit 51, the selector 57 for the computing unit groups in the first level, the selector 58 for the computing unit groups in the second level, and the selector 59 for the computing unit groups in the third level respectively delay the switch-timing signal output from the sequencer 31 and output the delayed signal to the register 54 for the computing unit groups in the first level, the register 55 for the computing unit groups in the second level, and the register 56 for the computing unit groups in the third level.

At the same time, when address information other than the specific address information is output from the sequencer 31, each selector 57, 58, and 59 outputs the switch-timing signal output from the sequencer 31 as it is. The circuit configuration output unit 4 does not receive the input of address information from the sequencer 31 for several cycles when the control operation to delay the output timing of the address information starts by the input of the specific address information.

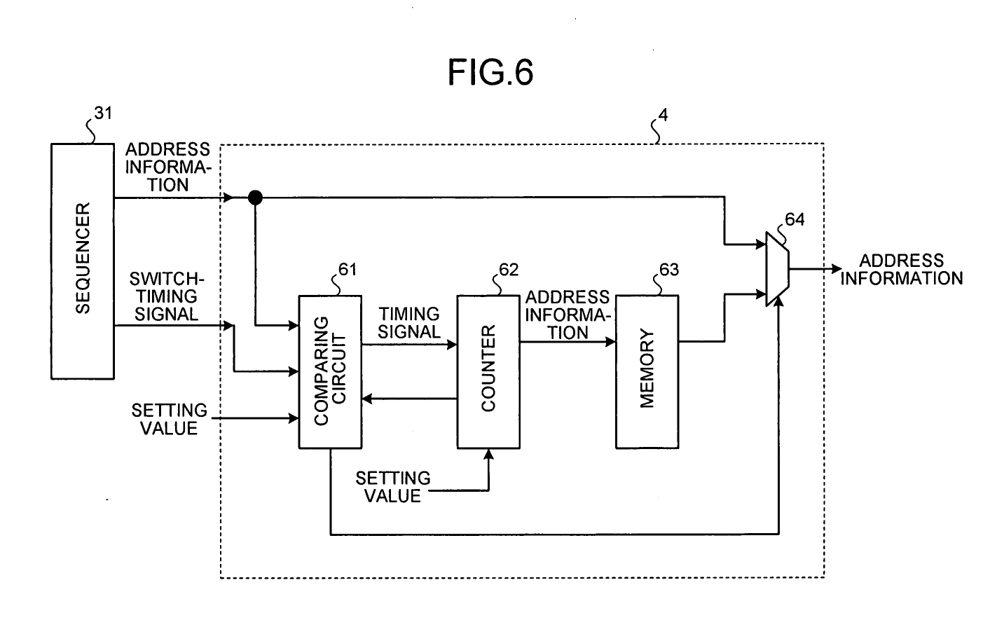

FIG. 6 is a diagram of an example of a configuration of the pattern output circuit. In the diagram, the switching of the circuit configurations of the computing unit groups is collectively controlled. The circuit configuration output unit 4 includes a comparing circuit 61, a counter 62, a memory 63, and a selector 64. The comparing circuit 61 compares the address information output from the sequencer 31 and the address information set in advance. If both address information match as a result of the comparison, the comparing circuit 61 activates the counter 62 and starts counting from zero. The comparing circuit 61 also switches the selector 64 to the memory 63.

The counter value of the counter 62 is sent to the memory 63. Address information output from the memory 63 is collectively transmitted to the computing unit groups via the selector 64, depending on the counter value. This operation continues until the counter value of the counter 62 reaches a value set in advance. Therefore, the circuit configuration output unit 4 outputs plural pieces of address information when the sequencer 31 outputs the address information only once. If neither address information match in the comparing circuit 61 or when the counter value of the counter 62 becomes the setting value, the selector 64 is switched to the sequencer 31. The address information output from the sequencer 31 is output as it is.

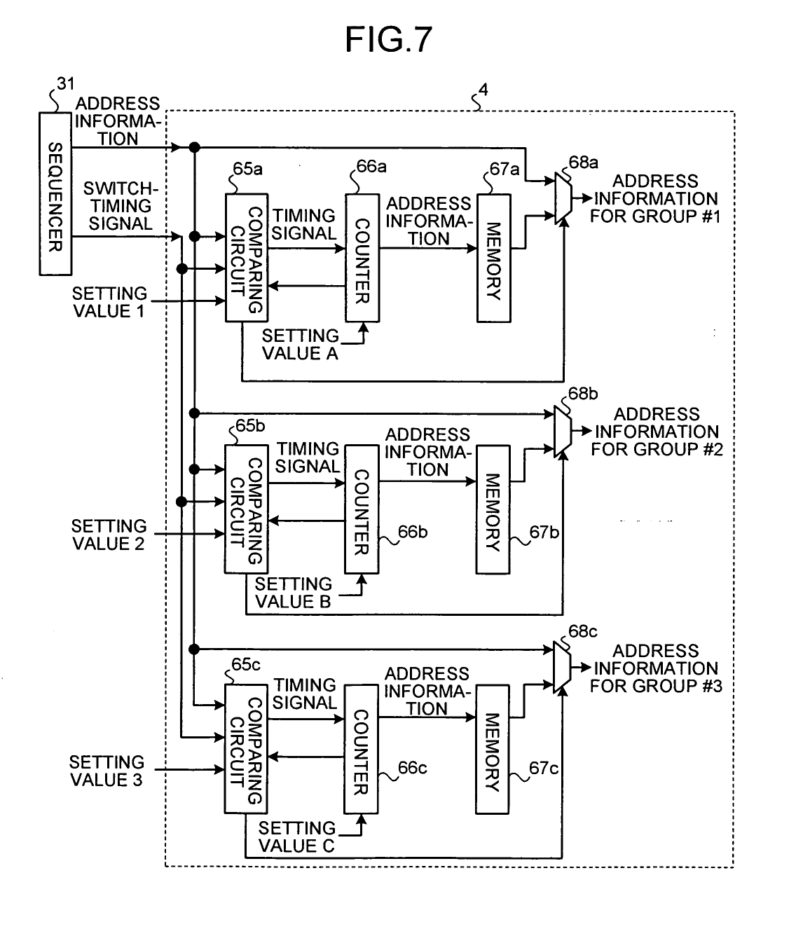

FIG. 7 is a schematic of the pattern output circuit included in the computing unit. The switching of the circuit configurations of the computing unit groups is controlled by each group. The circuit configuration output unit 4 has the same configuration as the pattern output circuit of the collective control method, described above, in each group. In other words, the circuit configuration output unit 4 has a comparing circuit 65a, a counter 66a, a memory 67a, and a selector 68a for the computing unit groups in the first level, a comparing circuit 65b, a counter 66b, a memory 67b, and a selector 68b for the computing unit groups in the second level, and a comparing circuit 65c, a counter 66c, a memory 67c, and a selector 68c for the computing unit groups in the third level.

A setting value 1, a setting value 2, and a setting value 3 of the address information of the comparing circuits 65a, 65b, and 65c can differ or be the same. A setting value A, a setting value B, and a setting value C of the counter values of the counters 66a, 66b, and 66c can differ or be the same. Conversion information stored in the memories 67a, 67b, and 67c can be differ or be the same. Thus, the address information for the computing unit groups in the first level, the address information for the computing unit groups in the second level, and the address information for the computing unit groups in the third level are respectively output from the electors 68a, 68b, and 68c. The address information for each group is sent to each computing unit group via a register (register 45 in FIG. 4, but not shown in FIG. 7).

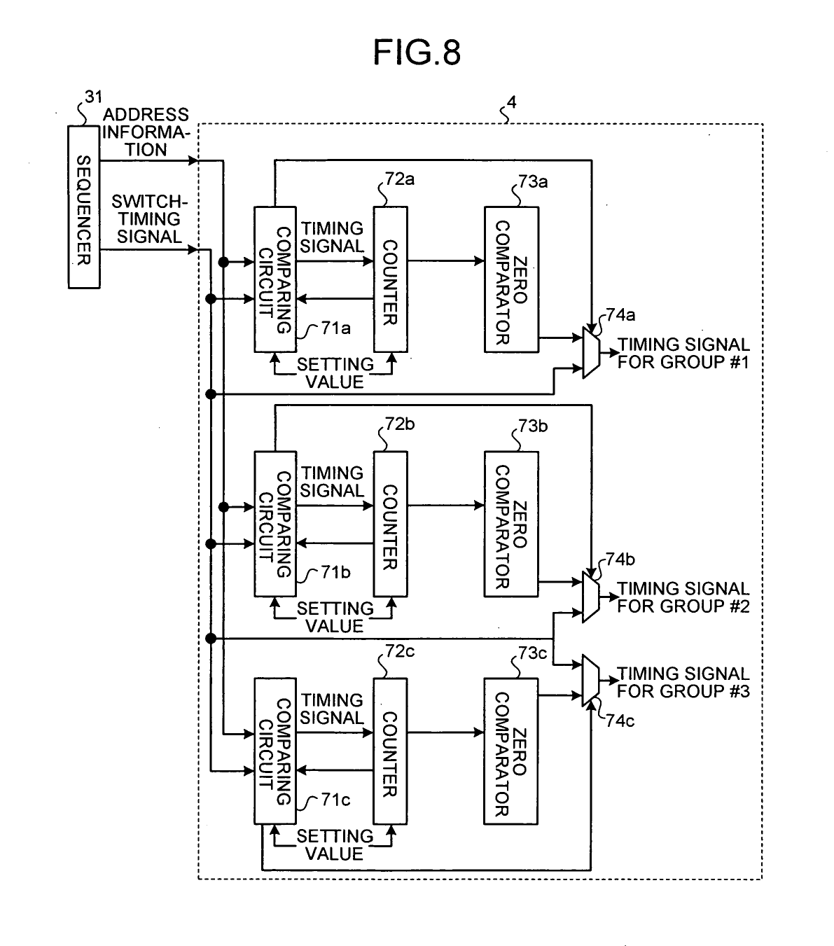

FIG. 8 is a schematic of the enable signal delay unit. The switch-timing signal is delayed for a plural number of cycles using the counter. The enable signal delay unit includes a comparing circuit 71a, a counter 72a, a zero comparator 73a, and a selector 74a for the computing unit groups in the first level, a comparing circuit 71b, a counter 72b, a zero comparator 73b, and a selector 74b for the computing unit groups in the second level, and a comparing circuit 71c, a counter 72c, a zero comparator 73c, and a selector 74c for the computing unit groups in the third level.

The comparing circuit 71a compares the address information output from the sequencer 31 and the address information set in advance. If both address information match as the result of the comparison, the comparing circuit 71a notifies the counter 72a of the timing. The counter 72a starts an automatic countdown from the value set in advance, upon receiving the notification. When the value of the counter 72a reaches zero, the selector 74a replaces the timing with the timing from the sequencer 31 and gives notification to the computing unit.

The comparing circuit 71a does not receive input from the sequencer 31 until the value of the counter 72 reaches zero by a control signal from the counter 72a. If the setting value does not match when the address information are compared in the comparing circuit 71a, the selector 71a notifies the computing unit of the switch-timing signal output from the sequencer 31 as it is. The same operation applies to the comparing circuit 71b, the counter 72b, the zero comparator 73b, and the selector 74b for the computing unit groups in the second level, and the comparing circuit 71c, the counter 72c, the zero comparator 73c, and the selector 74c for the computing unit groups in the third level.

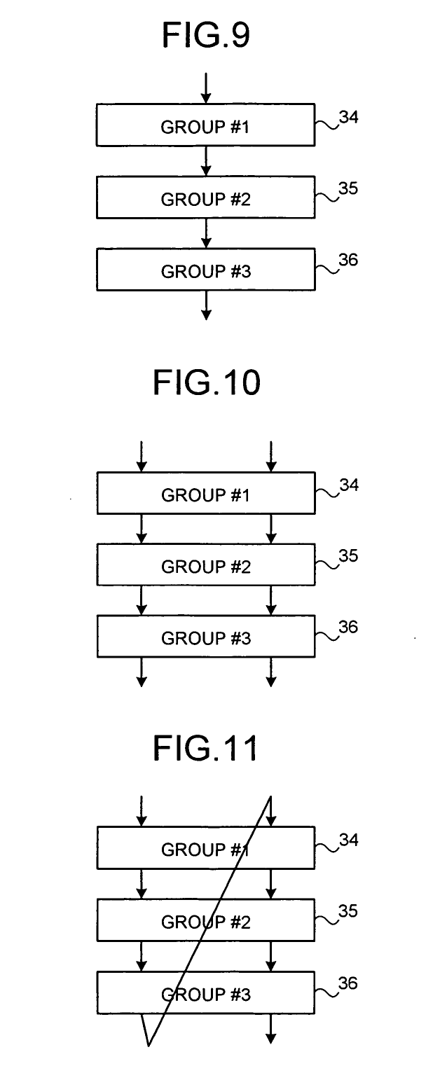

FIG. 9 is a schematic for illustrating a configuration of a three-level pipeline formed with the computing unit group 34 in the first level, the computing unit group 35 in the second level, and the computing unit group 36 in the third level. FIG. 10 is a schematic for illustrating a configuration of a parallel three-level pipeline formed with the computing unit group 34 in the first level, the computing unit group 35 in the second level, and the computing unit group 36 in the third level. In the computing unit groups 34, 35, and 36 of each level, the number of computing units placed on the three-level pipeline in the left-hand column in FIG. 10 and the number of computing units provided on the three-level pipeline in the right-hand column are variable. In other words, resources of each group can be distributed freely in the computing unit groups 34, 35, and 36 of each level.

FIG. 11 is a schematic for illustrating a configuration of a six-level pipeline formed with the computing unit group 35 in the second level, and the computing unit group 36 in the third level by returning the output of the three-level pipeline in the left-hand column to the input of the three-level pipeline in the right-hand column. As in the parallel three-level pipeline configuration, the resources of each computing unit group 34, 35, and 36 can be distributed freely. The pipeline is not limited to having three or six levels and can have two to five levels or seven levels and more. The computing unit group 34 in the first level, the computing unit group 35 in the second level, and the computing unit group 36 in the third level can be collectively reconfigured.

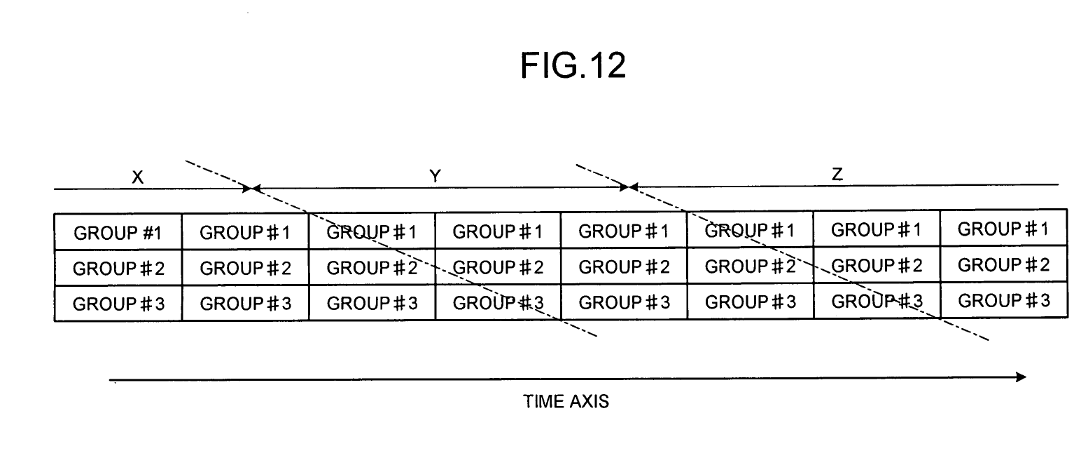

FIG. 12 is a schematic for illustrating an operation state of each computing unit group when the computing unit having the three-layer configuration is operated. When the computing unit 3 performs processing in the order of setting X (application image), setting Y (application image), and setting Z (application image), the switching of the circuit configuration of each computing unit group can be controlled by each group. Therefore, processing can be performed continuously, without idle between the setting X and the setting Y, and the setting Y and the setting Z, respectively.

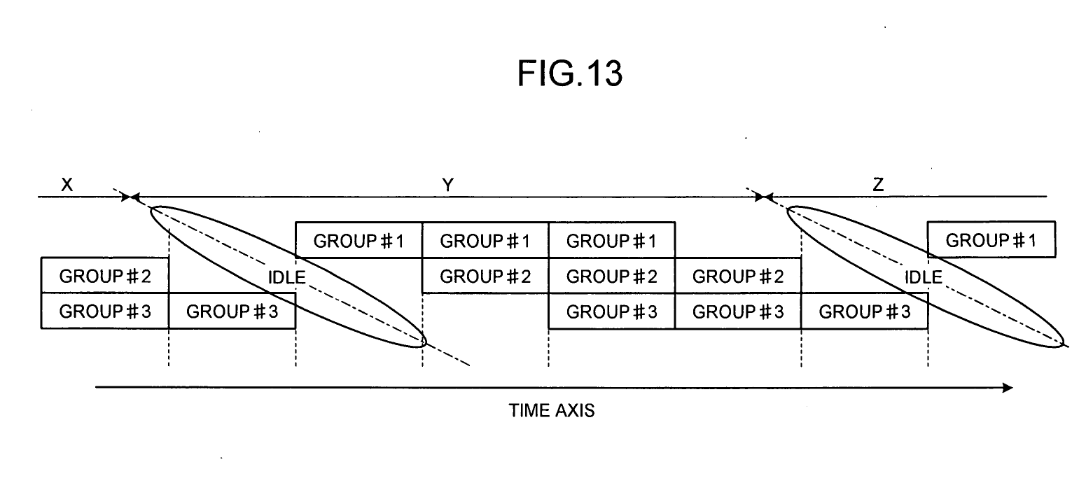

FIG. 13 is a schematic for illustrating an operation state of each computing unit group when the conventional reconfigurable computing device having the three-level pipeline configuration is operated. In the conventional computing unit 1, the circuit configurations of all computing unit groups are required to be switched collectively, after the processing of the computing unit group in the third level is completed. Therefore, idle occurs between the setting X and the setting Y, and the setting Y and the setting Z, respectively.

As explained above, according to the embodiment, the address information output from the sequencer 31 can be dynamically changed by the circuit configuration output unit 4 and provided to each computing unit group 34, 35, and 36. Moreover, the address information can be provided to each computing unit group 34, 35, and 36 at timings controlled for each group, and thus, the circuit configuration of each computing unit group 34, 35, and 36 can be switched by each group.

As a result, if the computing unit group 34 in the first level and the computing unit group 35 in the second level respectively have a circuit configuration M and a circuit configuration N, there are four possible combinations of the circuit configuration of the computing unit group 34 and the circuit configuration of the computing unit group 35: M and M, M and N, N and M, and N and N. The four combinations can be actualized in the computing unit 3 according to the embodiment merely by the circuit configuration information of M and the circuit configuration information of N. On the other hand, in the conventional computing unit 1, the circuit configuration of the computing unit group in the first level and the circuit configuration of the computing unit group in the second level are collectively switched, thereby requiring circuit configuration information of the four circuit configurations. In other words, according to the embodiment, the circuit configuration information required for reconfiguration can be halved, at the most.

According to the embodiments describe above, the circuit configurations of a plurality of reconfigurable computing unit groups can be switched for each of the computing unit groups.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A reconfigurable computing device comprising:
a plurality of computing unit groups each of which includes at least one computing unit;
a bus network configured to be reconfigurable and to use arbitrary output data of the computing unit groups as arbitrary input data for the computing unit groups;
a sequencer configured to output address information for controlling circuit configurations of the computing unit groups and switch-timing signals; and
a configuration output unit configured to make circuits of the computing unit groups reconfigurable for each of the computing unit groups, based on the address information and the switch-timing signals.

2. The reconfigurable computing device according to claim 1, wherein the circuit configuration output unit includes a delay unit configured to output the address information to the computing unit groups at timing controlled for each of the computing unit groups.

3. The reconfigurable computing device according to claim 2, wherein the delay unit is configured to control the timing based on specific address information.

4. The reconfigurable computing device according to claim 2, wherein the delay unit is configured to control the timing by delaying the switch-timing signal using a register.

5. The reconfigurable computing device according to claim 2, wherein the delay unit is configured to control the timing by delaying the switch-timing signal by predetermined cycles based on a count value of a counter.

6. The reconfigurable computing device according to claim 1, wherein the circuit configuration output unit includes an arithmetic operator configured to perform an arithmetic operation on the address information to dynamically change the address information.

7. The reconfigurable computing device according to claim 1, wherein the circuit configuration output unit includes a logic operator configured to perform a logic operation on the address information to dynamically change the address information.

8. The reconfigurable computing device according to claim 1, wherein the circuit configuration output unit includes a table used for conversion of the address information.

9. The reconfigurable computing device according to claim 1, wherein the circuit configuration output unit includes a circuit configured to decode the address information using a look-up table.

10. The reconfigurable computing device according to claim 1, wherein the circuit configuration output unit includes a pattern output circuit configured to output address information corresponding to a counter value of a counter that starts counting in response to specific address information.

11. The reconfigurable computing device according to claim 10, wherein the counter is provided for each of the computing unit groups.

12. The reconfigurable computing device according to claim 1, wherein the circuit configuration output unit includes an enable signal delay unit configured to output the address information to the computing unit groups at timing controlled for each of the computing unit groups by delaying the switch-timing signal for each of the computing unit groups.

13. The reconfigurable computing device according to claim 12, wherein the enable signal delay unit is configured to delay the switch-timing signal using a register, based on specific address information.

14. The reconfigurable computing device according to claim 12, wherein the enable signal delay unit is configured to delay the switch-timing signal by a predetermined number of cycles using a counter that starts counting in response to specific address information.

15. The reconfigurable computing device according to claim 14, wherein
the counter is provided in each of the computing unit groups, and
the predetermined number and the specific address information are set for each of the computing unit groups.

16. The reconfigurable computing device according to note 1, wherein the circuit configuration output unit includes an enable signal distributor configured to distribute the switch-timing signal for each computing unit group.

17. The reconfigurable computing device according to claim 1, wherein the sequencer is configured to output next address information for controlling the circuit configuration upon receiving a circuit configuration switch request signal from any one of the computing unit groups.
